(19) United States
(12) Patent Application Publication
(10) Pub. No.: US 2002/0192421 A1
(43) Pub. Date: Dec. 19, 2002

(54) Composite glassy carbon disk substrate for a data storage device and method for fabricating same

(76) Inventors: Timothy Allan Jennings, Rochester, MN (US); Douglas Howard Piltingsrud, Eyota, MN (US); Steven F. Starcke, Rochester, MN (US)

Correspondence Address: James R. Nock, IBM Corporation, Dept. 917, 3605 Highway 52 North, Rochester, MN, 55901-7829, US

(21) Appl. No.: 09/862,552

(22) Filed: May 22, 2001

(51) Int. Cl. B32B 3/02

(52) U.S. Cl. 428/64.1

(57) ABSTRACT

A disk substrate for a data storage device and a method for fabricating same. A glassy carbon layer is applied over a core. Preferably, the core is a ceramic, glass-ceramic, glass, glass composite, polymer, polymer composite, metal or metal composite having a high specific stiffness and temperature stability. The glassy carbon layer is formed by pyrolyzing a polymer precursor composition applied over the core. The precursor composition may be applied by a low cost technique such as ultrasonic coating, airbrushing and spin coating. The core having the precursor composition applied thereto is heated at a pyrolyzing temperature to form the glassy carbon layer. Preferably, before applying the precursor composition, the core is oxidized and/or etched and/or overcoated with a bonding layer to enhance the adhesion of the glassy carbon layer thereto. Prior to sputtering a recording layer thereon, the glassy carbon layer may be burnished to remove glide defects.

### FIELD OF THE INVENTION

The present invention relates in general to data storage systems. More particularly, the present invention relates to a composite glassy carbon disk substrate for a data storage system and a method for fabricating same.

### BACKGROUND

A typical data storage system includes a medium for storing data, typically in magnetic, magneto-optical or optical form, and a transducer used to write and read data respectively to and from the medium. A disk drive data storage system, for example, includes one or more data storage disks coaxially mounted on a hub of a spindle motor. The spindle motor rotates the data storage disks at speeds typically on the order of several thousand or more revolutions-per-minute. Digital information, representing various types of data, is typically written to and read from the data storage disks by one or more transducers, or read/write heads, which are mounted to an actuator assembly and passed over the surface of the rapidly rotating disks.

In a typical magnetic disk drive, for example, data is stored on a magnetic layer coated on a disk substrate. Several characteristics of disk substrates significantly affect the areal density and data rate performance of a disk drive. One such characteristic that significantly affects the areal density of a disk drive is the substrate stability temperature, i.e., the highest temperature at which the disk substrate is stable. Because the magnetic layer is typically sputtered onto the disk substrate, the substrate stability temperature limits the coercivity Hc of the magnetic layer. That is, the temperature at which the magnetic layer may be sputtered onto the disk substrate cannot exceed the substrate stability temperature. The coercivity Hc of the magnetic layer has a significant effect on the areal density a disk drive. Thus, the substrate stability temperature limits the coercivity Hc of the magnetic layer, and hence the areal density of the disk drive.

Another characteristic of disk substrates that significantly affects the areal density of a disk drive is the uniformity of the surface of the disk substrate, i.e., the absence of substrate surface defects. It is generally recognized that minimizing the flyheight, i.e., the clearance distance between the read/write head and the surface of a data storage disk, generally provides for increased areal densities. It is also recognized in the art, however, that the smoothness of the surface of a data storage disk becomes a critical factor and design constraint when attempting to minimize the flyheight. A significant decrease in flyheight provided by the use of data storage disks having highly uniform recording surfaces can advantageously result in increased transducer readback sensitivity and increased areal density of the disk drive. The uniformity of disk substrate surfaces affects the uniformity of the recording surfaces because the layers sputtered onto the disk substrate, such as the magnetic layer, replicate any irregular surface morphology of the disk substrate.

A characteristic of disk substrates that significantly affects the data rate performance of a disk drive is the substrate specific stiffness. It is generally recognized that increased disk spin rates, i.e., the speed at which the data storage disks rotate, generally provide increased data rate performance. However, higher disk spin rates (e.g., 10,000 rpm or greater) can produce disk flutter or vibration as the data storage disk works through operations of stopping, starting, varying speed and effecting actuator travel. Even at constant speed, disk flutter or vibration may result from turbulent air flow within the disk compartment or harmonic vibrations from the spindle motor.

Conventionally, disk substrates have been based upon aluminum, such as NiP coated Al/Mg alloy substrates. Coating the aluminum magnesium alloy with a nickel-phosphorus plate provides a harder exterior surface which allows the disk substrate to be polished and superfinished. Typically, the Al/Mg—NiP substrate is polished to a smooth finish with an alumina slurry or alumina and silica slurries prior to sputtering with thin film magnetic coatings. The alumina and silica slurries are cleaned from the substrate by the general cleaning mechanisms of mechanical scrubbing, dispersion and etching. After cleaning, the substrates are sputtered with a series of layers, e.g., a chrome underlayer, a magnetic layer and a carbon protection layer. If residual alumina particles are left on the substrate or there is galling to the relatively soft NiP layer, the sputtered layers replicate the irregular surface morphology, creating a bumpy surface on the finished disk. When the read/write head glides over the surface, it crashes into bumps created by the residual particles and/or damage that is higher than the glide clearance. This is known as a glide defect, which can ultimately cause disk drive failure. These bumps further cause magnetic defects, corrosion and decreased disk life. Thus, the residual slurry particles and/or damage needs to be removed from the polished substrate surface so that the substrate is as smooth as possible. Aluminum-based substrates have relatively low substrate stability temperature, surface glide uniformity (over the entire surface) and specific stiffness. For example, the relatively low specific stiffness of the Al/Mg—NiP substrates (typically 3.8 Mpsi/gm/cc) makes this type of disk substrate susceptible to environmental forces which create disk flutter and vibration. Moreover, metal-based substrates cannot be effectively micro-machined using a burnishing head to remove glide defects prior to applying the sputtered layers. For example, applying a burnishing head to an Al/Mg—NiP substrate adversely results in the galling of the NiP coating.

More recently, glass substrates have been used for disk drives in portable devices, such as laptop computers. Glass substrates have a higher impact and dent resistance than aluminum-based substrates, which is important in portable devices where the unit is subject to being bumped, dropped and banged around, causing the read/write head to bang on the disk substrate surface. Although the specific stiffness of glass or glass-ceramic substrates (typically ≦6 or 7 Mpsi/gm/cc) is typically higher than that of aluminum-based substrates, still higher specific stiffness is desirable.

An additional benefit of glass is that it is easier to polish to a smooth surface finish (as compared to NiP) than aluminum-based substrates. The surface uniformity of glass substrates can still present a problem, however, especially for low glide heights (typically ≦20 nanometers) and near contact recording. Just as with aluminum-based substrates, the surface of the glass substrate needs to be polished with a slurry to provide an atomically smooth surface prior to sputtering. For this polishing process, an aqueous slurry of lanthanide oxides is applied to the glass substrate. The lanthanide oxide slurries will typically comprise a major proportion of lanthanum and cerium particles. These slurry particles must subsequently be cleaned off, and this generally is accomplished in a series of steps, including ultrasonic cleaning and mechanical scrubbing (typically referred to as Oliver scrub cleaning) with soap and a pad to remove the loosest slurry. Unfortunately, after these cleaning processes, particles on the order of <0.1 μm (100 nanometers) still remain on the surfaces of the glass substrate. These particles are not easily removed from the substrate, as they are held to the surface by van der Waals forces, which are very significant at these particle sizes, hydrogen bonding, and molecular bonding of the particles to the surface. Just as with alumina particles, if these lanthanide oxide particles are left in place on the glass substrate, glide defects occur that can ultimately cause disk drive failure. These glide defects further cause magnetic defects, corrosion and decreased disk life. An apparent solution to this problem would be to use acid or base solutions to etch the disk or under-cut the particles similar to what is done to remove alumina particles from Al/Mg—NiP substrates. The surface finish of a glass substrate, however, can be damaged by such a method due to low resistance of the glass material to acid etching or overly aggressive acid solutions, such as hydrofluoric acid and caustic etching at high pH's and temperatures. Damage and compositional change to the polished glass surface will adversely affect the morphology of layers deposited by subsequent sputtering processes and can cause magnetic, glide and corrosion failures. Moreover, glass substrates cannot be effectively micro-machined using a burnishing head to remove the glide defects prior to applying the sputtered layers, such as a magnetic layer and a carbon protection layer. Applying the burnishing head to the glass surface typically causes micro-fracturing.

It is known that a thin layer of carbon may be sputtered on polished glass and electroless nickel-phosphorus disk substrates to yield a burnishable surface. See, “Method for Burnishing Substrates before Applying the Magnetic Film”, Research Disclosure, September 1992, Number 341, Kenneth Mason Publications Ltd., England. Although such a sputtered carbon overcoat is burnishable, the sputtering process tends to replicate the irregular surface morphology of Al/Mg—NiP and glass substrates. Thus, the glide defects will remain until a significant thickness of the sputtered carbon overcoat is polished, tape burnished, or micro-machined away using the burnishing head, which adds to the production cycle times and cost. Moreover, the sputtering process itself also adds to the production cycle times and cost.

Japanese Patent Document 8-81208 discloses an injection-molded glass-like carbon substrate which is purported to reduce processing costs. The glass-like carbon substrate is formed by injecting a fluid mixture of a resin and a curing agent into a mold, curing the resin, removing the cured resin from the mold, and carbonizing the cured resin by sintering. The injection-molded glass-like carbon substrate has relatively low surface uniformity because the formation process causes 20-60 vol. % shrinkage and the high porosity. In addition, the injection-molded glass-like carbon substrate has a relatively low specific stiffness (typically 2.2 Mpsi/gm/cc) because of the entire structure of the substrate is made up of the cured and sintered resin material.

Another alternative to aluminum-based substrates is the use of ceramic materials such as alumina, silicon carbide, boron carbide and boron carbide/aluminum composite. Ceramic materials such as these typically have relatively high specific stiffness and stability temperature. However, each of these materials has relatively low surface uniformity. These ceramic materials form surfaces that inherently include pits because they are not amorphous or a single crystal or have void volume because they are made from particles. Moreover, these ceramic materials cannot be effectively micro-machined using a burnishing head to remove the glide defects prior to applying the sputtered layers such as a magnetic layer and a carbon protection layer.

Attempts to solve this surface uniformity problem typically involve filling the pits in the surface of the ceramic material using NiP plating or sputtering on a cover layer. However, providing an overcoat using plating or sputtering processes adds to the production cycle times and costs. In addition, providing an overcoat using plating or sputtering processes typically does not work on ceramic surfaces because the pull-outs are too large (typically ≧5 microns deep and ≧5 microns across). Adding overcoat thickness to overcome this or reducing pit size in ceramics by grinding particles smaller and using hot isostatic pressing are cost prohibitive. In the case of NiP as an overcoat, the desired high substrate stability temperature is lost.

There exists in the data storage system manufacturing industry a keenly felt need to provide a disk substrate having superior stability temperature, surface uniformity and specific stiffness, and a method for fabricating same. There exists a further need to provide such a disk fabrication process that improves production cycle times and costs.

### SUMMARY OF THE INVENTION

An object of the present invention is to provide an enhanced disk substrate having superior stability temperature, surface uniformity and specific stiffness.

Another object of the present invention is to provide method for fabricating an enhanced disk substrate that improves production cycle times and costs for such a product.

These and other objects of the present invention are achieved by applying a glassy carbon layer over at least one surface of a core. Preferably the core is a ceramic, glass-ceramic, glass, glass composite, polymer, polymer composite, metal or metal composite having a high specific stiffness and temperature stability. More preferably, the core is a high specific stiffness and temperature stability ceramic, glass-ceramic, glass, glass composite, metal or metal composite. The glassy carbon layer is formed by pyrolyzing a glassy carbon polymer precursor composition applied over the surface of the core. The precursor composition may be applied by a low cost technique such as airbrushing, ultrasonic coating and spin coating. The core having the precursor composition applied thereto is heated at a pyrolyzing temperature to form the glassy carbon layer. The glassy carbon layer may comprise a glassy carbon formed by pyrolyzing at a temperature of at least 1000° C., or may comprise a pseudo glassy carbon pyropolymer formed by pyrolyzing at a temperature of 300° C. to 1000° C. Preferably, before applying the precursor composition, the core is oxidized and/or etched with at least one acid and/or caustic material, and/or overcoated with a bonding layer to enhance the adhesion of the glassy carbon layer to the core. The thickness of the glassy carbon layer preferably does not exceed 80 microns so as to provide a continuous matrix surface. Prior to sputtering a recording layer thereon, the glassy carbon layer may be polished and/or burnished to remove glide defects. The disk substrate can provide superior temperature stability, surface uniformity and specific stiffness. Additionally, the fabrication method can provide improved production cycle times and costs for this level of substrate performance. The surface provided may be textured with standard texturing processes known for NiP using alumina or diamond slurries, for example. The glassy carbon also provides a low energy surface that aids in cleaning and retains cleanliness.

### BRIEF DESCRIPTION OF THE DRAWINGS

The present invention together with the above and other objects and advantages can best be understood from the following detailed description of the embodiments of the invention illustrated in the drawings, wherein like reference numerals denote like elements.

FIG. 1A is a perspective view of a disk substrate which has a glassy carbon layer on both sides of a core according to an embodiment of the present invention.

FIG. 1B is a cross-sectional view of a disk substrate shown in FIG. 1A.

FIG. 2 is a top view of a data storage system with its upper housing cover removed and employing one or more data storage disks according to an embodiment of the present invention.

FIG. 3 is a side plan view of a data storage system comprising a plurality of data storage disks according to an embodiment of the present invention.

### DETAILED DESCRIPTION OF THE PREFERRED EMBODIMENTS

The present invention includes a composite glassy carbon disk substrate and a method for fabricating the same. The disk substrate generally includes an inner core and a glassy carbon layer applied over the inner core. Because the core preferably has a relatively high specific stiffness and stability temperature and because the glassy carbon layer preferably does not significantly detract from either of these characteristics, the composite glassy carbon disk substrate can provide superior specific stiffness and temperature stability as compared to conventional disk substrates. In essence, the specific stiffness and temperature stability of the disk substrate preferably is limited only by the core material. Moreover, because glassy carbon is an amorphous material, the glassy carbon layer may be polished to provide a pit free, atomically smooth surface finish. Preferably, the glassy carbon layer is sufficiently thin to avoid generating porosity due to outgassing and sufficiently thick to match the surface requirements for the substrate selected. The glassy carbon layer preferably provides a continuous matrix surface. Prior to sputtering a recording layer thereon, the glassy carbon layer may be polished and/or burnished to remove glide defects. Consequently, the composite glassy carbon disk substrate can provide superior surface uniformity as compared to conventional disk substrates, in addition to superior specific stiffness and temperature stability.

The glassy carbon layer is generally formed by pyrolyzing a glassy carbon polymer precursor composition applied over the surface of the core. The precursor composition may be applied by a low cost technique such as airbrushing, ultrasonic coating and spin coating. Thus, production cycle times and costs may be improved as compared to conventional overcoats that are applied using sputtering or plating techniques. The core having the precursor composition applied thereto is heated at a pyrolyzing temperature to form the glassy carbon layer. The glassy carbon layer may comprise either a glassy carbon or a pseudo glassy carbon pyropolymer as a function of the pyrolyzing temperature. Preferably, before applying the precursor composition, the core is oxidized and/or etched with at least one acid and/or caustic material, and/or overcoated with a bonding layer to enhance the adhesion of the glassy carbon layer to the core.

A storage disk for use in a data storage device may be provided by applying a recording layer over the glassy carbon layer.

### The Disk Substrate

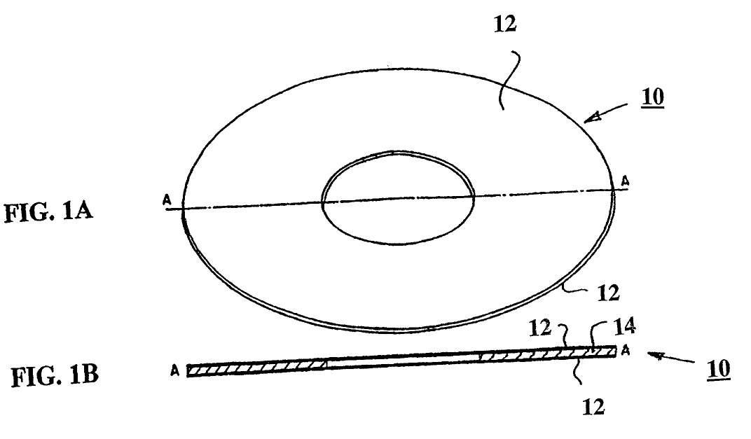

Referring to FIGS. 1A and 1B, there is shown an illustration of a composite glassy carbon disk substrate 10 according to one embodiment of the present invention. As shown, the disk substrate 10 comprises a glassy carbon layer 12 applied over both the top surface and the bottom surface of an inner core 14. Alternatively, the glassy carbon layer 12 may be applied over just one surface of the core 14. Preferably the core 14 is a ceramic, glass-ceramic, glass, glass composite, polymer, polymer composite, metal or metal composite having a high specific stiffness and temperature stability. More preferably, the core 14 is a ceramic, glass-ceramic, glass, glass composite, metal or metal composite having a relatively high specific stiffness (e.g., ≧3 Mpsi/gm/cc, more preferably ≧7.6 Mpsi/gm/cc) and a relatively high stability temperature, e.g., ≧300° C. Because the core 14 preferably has a relatively high specific stiffness and stability temperature and because the glassy carbon layer 12 preferably does not significantly detract from either of these characteristics, the composite glassy carbon disk substrate 10 can provide superior specific stiffness and temperature stability as compared to conventional disk substrates. For example, because glassy carbon may be stable to 2700° C. in a vacuum or inert atmosphere, the temperature stability of the disk substrate 10 may be limited only by the core material.

Any number of materials may be used for the inner core in accordance with the invention. Generally, the core may comprise any element, compound, or mixture thereof that provides the desired temperature stability (preferably, at least 300° C. and, more preferably, 320° C. to 2700° C.) and specific stiffness (preferably, at least 3 Mpsi/gm/cc, and, more preferably, at least 7.6 Mpsi/gm/cc, which is twice that of aluminum-based disk substrates, and, most preferably, 7.6 Mpsi/gm/cc to 30 Mpsi/gm/cc).

In the fabrication of the core, generally, compositions that may be used include ceramics, glass-ceramics, glasses, glass composites, polymers, polymer composites, metals and metal composites. Examples of materials that may be used as the core include alumina, sapphire, silicon carbide, boron carbide, metal matrix composites, and aluminum/boron carbide composites. Other examples of materials that may be used as the core include carbides, nitrides, oxides and phosphides or mixtures thereof. Still another example of a material that may be used as the core is a fiber reinforced composite such as graphite fiber reinforcement.

Metal matrix composites are made by pigmenting a metal, such as aluminum, with a ceramic powder. The mixture is then melted and formed into a core. The concentration of ceramic powder is balanced to provide optimal physical properties.

Other materials that may be fabricated into composites that may be used for the core include those such as silicon carbide, sapphire, titanium nitride, boron carbide, boron nitride, carbon, silicon nitride, as well as composites of glass and ceramic.

A representative list of compositions along with their relative specific stiffnesses (Mpsi/gm/cc) that may be used is found in Table 1 below.

TABLE 1

| Specific | Material Stiffness |
|---|---|
| Aluminum | 3.8 |
| Aluminosilicate glass | 4.9 |
| Lithium silicate glass | 5.2 |
| Canasite glass ceramic | 4.6 |
| Flint glass ceramic | 6.6 |
| Quartz glass | 4.9-6.1 |
| Titanium alloy | 3.3 |
| Zirconia | 5.1 |
| Alumina | 14.7 |
| Silicon carbide | 15.7-19.5 |
| Beryllium | 22.5 |
| Carbon | 2.2 |
| Alumina/aluminum composite | 5.3 |
| Boron carbide | 26.1 |
| Boron carbide/aluminum composite | 11.1-21.2 |

These materials may be used above or in combination to provide the core of the appropriate stiffness. Preferably, the core has a stiffness of at least about 3 Mpsi/gm/cc, more preferably at least 7.6 Mpsi/gm/cc, most preferably from about 7.6 Mpsi/gm/cc to 30 Mpsi/gm/cc.

Other useful materials for the core include glass compositions, ceramics, and mixtures thereof. Glass is generally a silicate material having a structure of silicon and oxygen where the silicon atom is tetrahedrally coordinated to surrounding oxygen atoms. Any number of materials may be used to form glass such as boron oxide, silicon oxide, germanium oxide, aluminum oxide, phosphorous oxide, vanadium oxide, arsenic oxide, antimony oxide, zirconium oxide, titanium oxide, aluminum oxide, thorium oxide, beryllium oxide, cadmium oxide, scandium oxide, lanthanum oxide, yttrium oxide, tin oxide, gallium oxide, indium oxide, lead oxide, magnesium oxide, lithium oxide, zinc oxide, barium oxide, calcium oxide, stronium oxide, sodium oxide, cadmium oxide, potassium oxide, rubidium oxide, mercury oxide, and cesium oxide.

Glass-ceramics may also be used for the core. Glass-ceramics generally result from the melt formation of glass and ceramic materials by conventional glass manufacturing techniques. Subsequently, the materials are heat cycled to cause crystallization. Typical glass-ceramics are, for example, β-quartz solid solution, SiO₂; β-quartz; lithium metasilicate, Li₂O—SiO₂; lithium disilicate, Li₂(SiO₂)₂; 3-spodumene solid solution; anatase, TiO₂; β-spodumene solid solution; rutile TiO₂; β-spodumene solid solution; mullite, 3Al₂O₃—2SiO₂; β-spodumene dorierite, 2MgO—2Al₂O₃—5SiO₂; spinel, MgO—Al₂O₃; MgO-stuffed; β-quartz; quartz; SiO₂; alpha-quartz solid solution, SiO₂; spinel, MgO—Al₂O₃; enstatite, MgO—SiO₂; fluorphlogopite solid solution, KMg₃AlSi₃O₁₀F₂; mullite, 3Al₂O₃—2SiO₂; and (Ba, Sr, Pb)Nb₂O₆.

Ceramics are generally comprised of aluminum oxides such as alumina, silicon oxides, zirconium oxides such as zirconia or mixtures thereof. Typical ceramic compositions include aluminum silicate; bismuth calcium strontium copper oxide; cordierite; feldspar, ferrite; lead lanthanum zirconate titanate; lead magnesium nobate (PMN); lead zinc nobate (PZN); lead zirconate titanate; manganese ferrite; mullite; nickel ferrite; strontium hexaferrite; thallium calcium barium copper oxide; triaxial porcelain; yttrium barium copper oxide; yttrium iron oxide; yttrium garnet; and zinc ferrite.

Aluminum-boron-carbide composite may also be used for the core, preferably with a ratio of aluminum to boron carbide (vol. %) ranging from about 1:99 to 40:60. The specific stiffness of these materials typically ranges from about 11.1 to 21.2 Mpsi/gm/cc. Lower stiffness disks may suffer from vibration. These disks are commonly referred to as aluminum-boron-carbide composites or AlBC composites.

The disk substrate 10 of the invention also comprises a glassy carbon layer 12. The glassy carbon layer 12 functions to provide a polishable and burnishable defect free surface, preferably without significantly detracting from the specific stiffness and temperature stability of the core 14. As discussed in more detail below, the glassy carbon layer 12 is formed by pyrolyzing a glassy carbon polymer precursor composition applied over the surface of the core 14. The glassy carbon layer 12 may comprise either a glassy carbon or a pseudo glassy carbon pyropolymer, depending on the temperature at which the polymer precursor composition is pyrolyzed.

The glassy carbon layer 12 must also be adherent to the core 14. To enhance the adhesion of the glassy carbon layer 12 to the core 14, as discussed in more detail below, the core 14 is preferably oxidized and/or etched with at least one acid and/or caustic material, and/or overcoated with a bonding layer (not shown) before the polymer precursor composition is applied to the core 14.

Generally, any number of polymer precursor compositions may be used to create the glassy carbon layer 14. Typically, polymer precursors for glassy carbon (also commonly called vitreous carbon or polymeric carbon) are three dimensional cross-linking polymers. Carbonization takes place in the solid state (no mesophase as forms for cokes) and results in the formation of a char. The char or carbon yield correlates with the molecular weight and degree of aromaticity, higher being better. The polymer precursor compositions used to make glassy carbon are typically low cost. Representative polymer precursor compositions which may be used for the glassy carbon layer include phenolics (e.g., phenol-formaldehyde), polyfurfuryl alcohol, cellulose, polybutylene, polyacrylonitrile, polyvinylidene chloride, polyvinyl chloride, polyvinyl fluoride, polyimides, styrene-divinylbenzene co-polymer, polyphenylene oxide, polyphenylene sulfide, polyarylacrylates, phenylacetylenes, and mixtures thereof. Typically, the polymer precursor composition is dissolved in an organic solvent to produce a solution. Preferably any insoluble matter that remains in the solution is filtered out. An example of such a solution is a filtered solution made from Ruff Out-DV (available from ORPAC Inc., Oak Ridge, Tenn.) and a mixture of ethanol:ethylacetate.

Because glassy carbon is an amorphous material, the glassy carbon layer 12 may be polished to provide a pit free, atomically smooth surface finish. The measured porosity in glassy carbon from the inherent 3D structure is extremely low (typically, <5 Å pores). Glassy carbon polishes nicely with a standard slurry approach, such as alumina or silica. Preferably, the thickness of the glassy carbon layer 12 does not exceed 80 microns so as to provide a continuous matrix surface. In addition, as discussed in more detail below, the glassy carbon layer 12 is burnishable. Thus, before a recording layer (not shown) is sputtered over the glassy carbon layer 12, the glassy carbon layer 12 may be burnished to remove glide defects. Consequently, the glassy carbon layer 12 can provide a disk substrate having superior surface uniformity. A significant decrease in flyheight can be achieved due to the highly uniform, glide defect free surface provided by the glassy carbon layer 12. In turn, the decreased flyheight can advantageously result in increased transducer readback sensitivity and increased areal density.

These traits, along with low material and processing costs and the ability to cover over defects on the surface of the core 14, make the present invention an attractive solution to keenly felt needs in the data storage system manufacturing industry.

The disk substrate 10 may then be further processed and finished by any other means known to those of skill in the art.

### Processing

The glassy carbon layer 12 is formed by pyrolyzing a glassy carbon polymer precursor composition applied over the surface of the core 14. The precursor composition may be applied to the core 14 by a low cost technique such as airbrushing, ultrasonic coating and spin coating. Thus, production cycle times and costs may be improved as compared to conventional overcoats that are applied using sputtering or plated techniques. Moreover, application techniques such as airbrushing, ultrasonic coating and spin coating are more defect filling than plating or sputter techniques, thereby allowing use of less expensive core materials.

Preferably, before applying the glassy carbon polymer precursor composition, the core 14 is oxidized and/or etched with at least one acid and/or caustic material, and/or overcoated with a bonding layer to enhance the adhesion of the glassy carbon layer 12 to the core 14. The adhesion or bond between the glassy carbon layer 12 and the core 14 is an important factor in minimizing peeling and cracking in the glassy carbon layer 12. Peeling and cracking may occur, for example, in the process of heating and cooling during the formation of the disk substrate and during subsequent sputtering thereon and each has a dependancy on the coating thickness, adhesion strength, difference in coefficients of thermal expansion, and the pyrolysis temperature used.

Adhesion/bonding of one layer to another occurs thru various types of intermolecular interactions between molecules generally described by three classifications roughly going from weakest to strongest: polarization force (London dispersion forces); coulombic forces or acid/base bonding (van der Waals bonding, hydrogen bonding and ionic bonds); and quantum mechanical force (covalent or chemical bonding). As the contact surface area of a disk surface increases due to roughness, the contribution for these forces per unit film thickness naturally also increases as does the potential for physical interlocking. Thus, adhesion/bonding is improved by activating these bonding forces, increasing the surface area available for such bonding, and providing in some cases physical interlocking. Increases in surface area or physical interlocking are physical in nature and are provided by either chemical etch or mechanical roughening (typically provided by processes such as lapping/polish). Increases in molecular interactions, on the other hand, are chemical in nature.

Adhesion/bonding may be enhanced by, for example, treating the surface of the core with at least one caustic and/or acid etchant to generate reactive hydroxyl groups and acid surface sites before applying the glassy carbon polymer precursor composition. Surface roughness may also be generated by the etchant. Increasing the number of hydroxyl groups on the surface of the core was found to be particularly effective. Useful acid etchants generally include inorganic acids such as nitric acid, nitrous acid, sulfuric acid, sulfurous acid, sulfamic acid, phosphoric acid, pyrophosphoric acid, phosphorous acid, perchloric acid, hydrochloric acid, chlorous acid, hypochlorous acid, hydrofluoric acid, carbonic acid, chromic acid, and combinations thereof. Of course, the acid etchant may also be an organic acid such as formic acid and citric acid. Useful caustic etchants generally include inorganic bases such as lithium hydroxide, sodium hydroxide, potassium hydroxide, calcium hydroxide, and ammonium hydroxide. Any one or a combination of these etchants may be used is a single etching operation or successive etching operations. In an example of successive etching operations, the core may be treated with a caustic etchant and then with an acid etchant, or vice versa.

For example, the core may be dipped in a sodium hydroxide solution, and then water rinsed. Then, the core may be dipped in a nitric acid solution, and then rinsed. The core may then be dipped in isopropyl alcohol and allowed to dry. Of course, the core may be sprayed with the etchant solutions in lieu of being dipped therein.

Alternatively, or in addition, the core may be surface treated by oxidation to enhance adhesion/bonding before applying the glassy carbon polymer precursor composition. Alternatively, or in addition, the core may be surface treated to generate roughness by conventional lapping and/or polish techniques to enhance adhesion/bonding before applying the glassy carbon polymer precursor composition.

Adhesion/bonding may also be enhanced by coating the surface of the core with a bonding layer before applying the glassy carbon polymer precursor composition. The bonding layer may be a thin film of inorganic or metal organic reactive adhesive agent such as inorganic or organic complexes of Ti, Zr, Al, or Si. For example, the bonding layer may be applied by dipping the core in a glacial acetic acid treated solution of tetraethylorthosilicate in isopropyl alcohol, or by spraying the core therewith.

The thickness of the glassy carbon layer 12 is another important factor in minimizing peeling and cracking therein. In this regard, it is desirable to keep the glassy carbon layer 12 relatively thin. The thickness of the glassy carbon layer 12 may be about 10 Å (0.001 microns) to about 200 microns. Preferably, the thickness of the glassy carbon layer is 0.01 microns to 80 microns and, more preferably, 0.1 microns to 30 microns. In general, the thickness of the glassy carbon layer may be limited by factors such as its adhesion to the core, the pyrolysis temperature, and the difference between the coefficient of thermal expansion (CTE) of the core 14 and the CTE of the glassy carbon layer 12. Typically, a larger CTE difference calls for a thinner glassy carbon layer 12. Generally, the use of fillers in the glassy carbon layer 12 to change the CTE thereof and/or reduce porosity formation is undesirable as it would induce substrate surface defects.

The coefficient of thermal expansion (CTE) of glassy carbon pyrolyzed at a temperature of 1000° C. or above is 2-4×10⁻⁶/° C., while CTE's are higher for glassy carbon pyrolyzed at lower temperatures. This is a good match for the CTE's of any number of core materials, such as high stiffness ceramics (the CTE for silicon carbide 2.3-4.5×10⁻⁶/° C., for alumina about 7×10⁻⁶/° C.).

The flatness of the core 14 can be improved by changing surface to surface coating thickness of the glassy carbon layers 12 if desired. That is, the glassy carbon layer 12 may be made thicker on one surface of the core 14 relative to that on the other surface of the core 14, thereby inducing a stress differential that may be utilized to improve the flatness of the core 14.

The glassy carbon layer 12 is formed by pyrolyzing a glassy carbon polymer precursor composition applied over the surface of the core 14. The glassy carbon layer 12 may comprise either a glassy carbon or a pseudo glassy carbon pyropolymer, depending on the temperature at which the polymer precursor composition is pyrolyzed. Generally, pyrolysis at a temperature of at least about 1000° C. yields glassy carbon, while pyrolysis at temperature of about 300° C. to about 1000° C. yields a pseudo glassy carbon pyropolymer. The temperature of 1000° C. is chosen as the break point because in general polymers lose all their non-carbon content by 1000° C. (carbonization process). The heating time and temperature will vary depending on the polymer precursor composition. It may be desirable to pre-oxidize the polymer precursor composition in air at up to 250° C.

Because glassy carbon is an amorphous material, the glassy carbon layer 12 may be polished to provide a pit free, atomically smooth surface finish. The measured porosity in glassy carbon from the inherent 3D structure is extremely low (typically, <5 Å pores). Preferably, the thickness of the glassy carbon layer 12 does not exceed 80 microns so as to provide a continuous matrix surface. Glassy carbon polishes nicely with a standard slurry approach, for example, using conventional alumina slurry or alumina and silica slurries or diamond slurries. The alumina, silica and diamond slurries may be cleaned from the disk substrate by conventional cleaning mechanisms such as mechanical and chemical dispersing.

In addition, the glassy carbon layer 12 is burnishable. Thus, before a recording layer is sputtered over the glassy carbon layer 12, the glassy carbon layer 12 may be burnished to remove glide defects. Conventional burnishing apparatus and methods may be used in this regard. Methods and apparatus for burnishing disks are well known in the art. See, for example, U.S. Pat. No. 5,018,311, entitled “Magnetic Disk Burnishing Method and Apparatus”, issued May 28, 1991 to Malagrino et al. See also, for example “Method for Burnishing Substrates before Applying the Magnetic Film”, Research Disclosure, Number 341, Kenneth Mason Publications Ltd., England, September 1992.

The glassy carbon layer 12 may be burnished by using a conventional burnishing head or burnishing tape, for example. Glide defects on the surface of the glassy carbon layer 12 are machined off as the burnishing head or burnishing tape is run over the glassy carbon surface of the rotating disk substrate 10. This step is sometimes referred to herein as micro-machining. Prior to the micro-machining step, the glassy carbon layer 12 is preferably lubed with a hydrocarbon lubricant such a linear or branched alcohol or alcohol alkoxylate. For example, the disk substrate may be dipped in the hydrocarbon lubricant. Alternatively, the hydrocarbon lubricant may be sprayed on the disk substrate. After the micro-machining step, the hydrocarbon lubricant may be removed from the glassy carbon layer 12 by a conventional pre-sputter cleaning process using an aqueous or non-aqueous cleaning solution, for example.

The composite glassy carbon disk substrate 10 may then be further processed and finished by any other means known to those of skill in the art. After cleaning, for example, the composite glassy carbon disk substrate may be sputtered with a series of layers, e.g., a magnetic layer and a carbon protection layer, using any of the various techniques that are conventional in the art.

### The Data Storage Device

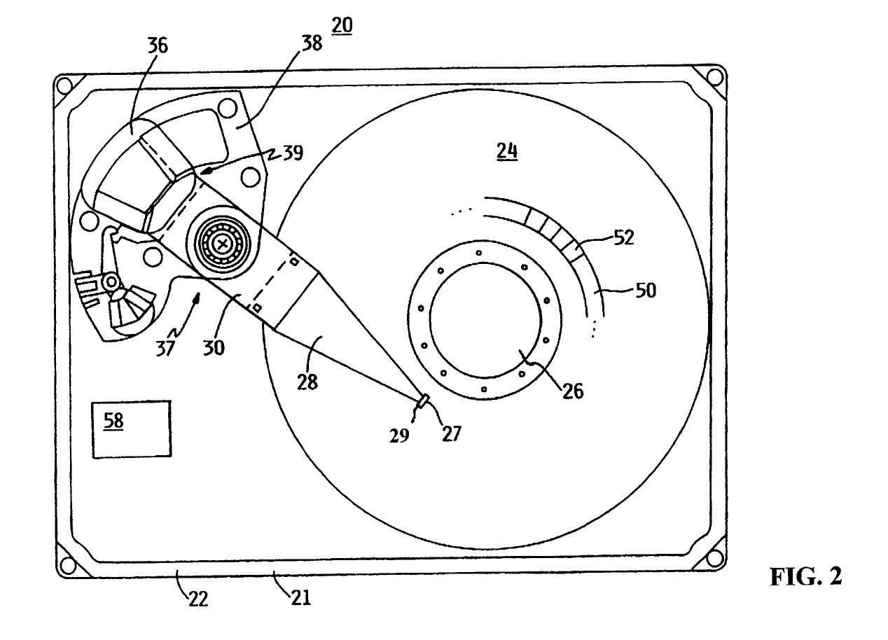

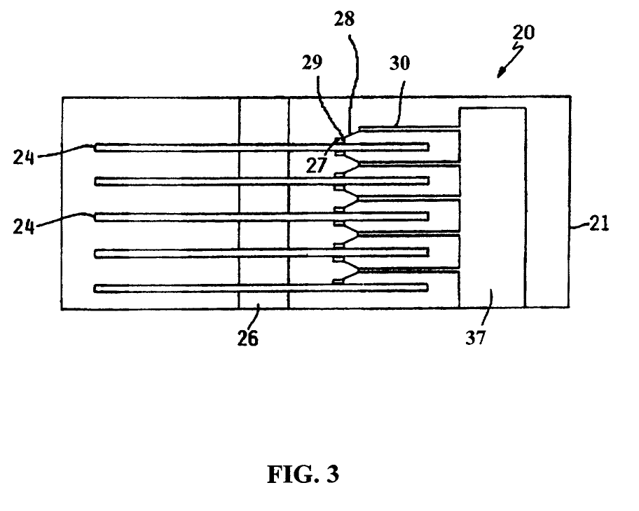

Referring now to the drawings, and more particularly to FIG. 2, there is shown a magnetic data storage system 20 with its cover (not shown) removed from the base 22 of the housing 21. As best seen in FIG. 3, the magnetic data storage system 20 includes one or more rigid data storage disks 24 that are rotated by a spindle motor 26. The rigid data storage disks 24 are constructed with a composite glassy carbon disk substrate upon which a recording layer is formed. In one exemplary construction, a magnetizable recording layer is formed on a composite glassy carbon disk substrate having a ceramic or glass core. In another exemplary construction, an aluminum optical recording layer is formed on a composite glassy carbon disk substrate having a plastic core.

Referring back to FIG. 2, an actuator assembly 37 typically includes a plurality of interleaved actuator arms 30, with each arm having one or more suspensions 28 and transducers 27 mounted on airbearing sliders 29. The transducers 27 typically include components both for reading and writing information to and from the data storage disks 24. Each transducer 27 may be, for example, a magnetoresistive (MR) head having a write element and a MR read element. Alternatively, each transducer may be an inductive head having a combined read/write element or separate read and write elements, or an optical head having separate or combined read and write elements. The actuator assembly 37 includes a coil assembly 36 which cooperates with a permanent magnet structure 38 to operate as an actuator voice coil motor (VCM) 39 responsive to control signals produced by controller 58. The controller 58 preferably includes control circuitry that coordinates the transfer of data to and from the data storage disks 24, and cooperates with the VCM 39 to move the actuator arms 30 and suspensions 28, to position transducers 27 to prescribed track 50 and sector 52 locations when reading and writing data from and to the disks 24.

While this invention has been described with respect to the preferred and alternative embodiments, it will be understood by those skilled in the art that various changes in detail may be made therein without departing from the spirit, scope, and teaching of the invention. For example, the invention may be utilized in systems employing optical storage medium. Additionally, the invention may be utilized in applications other than data storage medium applications, such as in semiconductor fabrication applications. Accordingly, the herein disclosed invention is to be limited only as specified in the following claims.

### EXAMPLE

Etch Surface Treatment

A 65 mm diameter aluminum-boron-carbide (AlBC) core was first etched by dipping in 8.75 vol. % NaOH for 20 seconds, then rinsed in deionized water for 60 seconds. Then the AlBC core was dipped in 25 vol. % HNO₃ for 60 seconds, and then rinsed in deionized water for 60 seconds. Then the AlBC core was dipped in 100 vol. % isopropyl alcohol and allowed to dry.

Applying the Bonding Layer

Next the AlBC core was dip coated in a glacial acetic acid treated solution of 2 vol. % tetraethylorthosilicate in isopropyl alcohol. This solution was made by first adding five drops of glacial acetic acid to 10 cc deionized water. Then three drops of this mixture were added to 100 cc of the 2 vol. % tetraethylorthosilicate and aged 24 hours before being used to dip coat the AlBC core. The AlBC core was dipped in this solution for 30 seconds, then withdrawn at 0.8 mm/sec. This dip/withdrawal process was repeated 4 times.

Applying the Glassy Carbon Polymer Precursor Composition

Then the resulting dip coated AlBC core was spray coated to form a glassy carbon polymer precursor composition coating having a thickness of 40 microns . The polymer precursor composition was Ruff Out-DV (available from ORPAC Inc., Oak Ridge, Tenn.) from a 0.45 micron filtered solution of 1.5 parts 1:1 mixture of ethanol:ethylacetate to 1 part Ruff Out-DV.

Curing/Pre-oxidizing and Pyrolyzing the Glassy Carbon Polymer Precursor Composition

Next the AlBC core coated with the polymer precursor composition was set flat in a room temperature oven and heated in air to 110° C. at 2 degrees C./min. The temperature was held at 110° C. for 1 hour. Then, the temperature was increased at a rate of 3 degrees C./min to 190° C. The temperature was held at 190° C. for 2 hours. The resulting disk substrate was then hung vertically in a kiln with a 5% hydrogen, 95% argon atmosphere and heated to 190° C. at 600 degrees C./hour, then to 500° C. at 100 degrees C./hour. The temperature was held at 500° C. for 2 hours, then cooled to room temperature.

Polishing the Composite Glassy Carbon Disk Substrate

The resulting composite glassy carbon disk substrate was polished with a conventional alumina slurry. This slurry is typically used to polish conventional disk substrates that are coated with NiP. The polished composite glassy carbon disk substrate was then subjected to a conventional cleaning operation, i.e., PVA (polyvinyl alcohol) scrubbing, deionized water and surfactants.

What is claimed is:

1. A disk substrate for use in a storage device, said disk substrate comprising:
a core;
a glassy carbon layer applied over at least one surface of said core, said glassy carbon layer adhering to said surface of said core.

2. The disk substrate as recited in claim 1, wherein said glassy carbon layer has a thickness not exceeding about 80 microns.

3. The disk substrate as recited in claim 1, wherein said glassy carbon layer has a thickness of about 0.1 microns to about 30 microns.

4. The disk substrate as recited in claim 2, wherein said glassy carbon layer provides a continuous matrix surface.

5. The disk substrate as recited in claim 1, wherein said glassy carbon layer comprises a glassy carbon formed by pyrolyzing a polymer precursor composition at a temperature of at least about 1000° C.

6. The disk substrate as recited in claim 1, wherein said glassy carbon layer comprises a pseudo glassy carbon pyropolymer formed by pyrolyzing a polymer precursor composition at a temperature of about 300° C. to about 1000° C.

7. The disk substrate as recited in claim 1, wherein said glassy carbon layer is adhered to said surface of said core through a bonding layer.

8. The disk substrate as recited in claim 7, wherein said bonding layer comprises a thin film of an inorganic or metal organic reactive adhesive agent selected from the group consisting of an organic complex of silicon, an organic complex of titanium, an organic complex of aluminum, an organic complex of zirconium, an inorganic complex of silicon, an inorganic complex of titanium, an inorganic complex of aluminum, an inorganic complex of zirconium, and mixtures thereof.

9. The disk substrate as recited in claim 1, wherein said core has a specific stiffness of at least about 3 Mpsi/gm/cc.

10. The disk substrate as recited in claim 9, wherein said disk substrate has a specific stiffness of at least about 7.6 Mpsi/gm/cc and a stability temperature of at least about 300° C.

11. The disk substrate as recited in claim 1, wherein said core comprises a material selected from the group consisting of alumina, silicon carbide, boron carbide, and an aluminum/boron carbide composite.

12. The disk substrate as recited in claim 1, wherein said core comprises a material selected from the following: ceramic, glass-ceramic, glass, glass composite, polymer, polymer composite, metal and metal composite.

13. The disk substrate as recited in claim 1, wherein said core has a specific stiffness of at least about 7.6 Mpsi/gm/cc, said glassy carbon layer provides a continuous matrix surface, and said disk substrate has a stability temperature of at least about 300° C.

14. The disk substrate as recited in claim 13, wherein said glassy carbon layer provides a burnishable surface.

15. A storage device, comprising:
a storage disk comprising a disk substrate, said disk substrate comprising a core and a glassy carbon layer applied over at least one surface of said core, said glassy carbon layer adhering to said surface of said core, said storage disk further comprising a recording layer applied over said glassy carbon layer;
a transducer;
an actuator provided to position said transducer relative to said storage disk;
a motor provided to rotate said storage disk relative to said transducer at a rated storage disk velocity.

16. The storage device as recited in claim 15, wherein said glassy carbon layer has a thickness not exceeding about 80 microns.

17. The storage device as recited in claim 15, wherein said glassy carbon layer has a thickness of about 0.1 microns to about 30 microns.

18. The storage device as recited in claim 16, wherein said glassy carbon layer provides a continuous matrix surface.

19. The storage device as recited in claim 15, wherein said glassy carbon layer comprises a glassy carbon formed by pyrolyzing a polymer precursor composition at a temperature of at least about 1000° C.

20. The storage device as recited in claim 15, wherein said glassy carbon layer comprises a pseudo glassy carbon pyropolymer formed by pyrolyzing a polymer precursor composition at a temperature of about 300° C. to about 1000° C.

21. The storage device as recited in claim 15, wherein said glassy carbon layer is adhered to said surface of said core through a bonding layer.

22. The storage device as recited in claim 21, wherein said bonding layer comprises a thin film of an inorganic or metal organic reactive adhesive agent selected from the group consisting of an organic complex of silicon, an organic complex of titanium, an organic complex of aluminum, an organic complex of zirconium, an inorganic complex of silicon, an inorganic complex of titanium, an inorganic complex of aluminum, an inorganic complex of zirconium, and mixtures thereof.

23. The storage device as recited in claim 15, wherein said core has a specific stiffness of at least about 3 Mpsi/gm/cc.

24. The storage device as recited in claim 23, wherein said disk substrate has a specific stiffness of at least about 7.6 Mpsi/gm/cc and a stability temperature of at least about 300° C.

25. The storage device as recited in claim 15, wherein said core comprises a material selected from the group consisting of alumina, silicon carbide, boron carbide, and an aluminum/boron carbide composite.

26. The storage device as recited in claim 15, wherein said core comprises a material selected from the following: ceramic, glass-ceramic, glass, glass composite, polymer, polymer composite, metal and metal composite.

27. The storage device as recited in claim 15, wherein said core has a specific stiffness of at least about 7.6 Mpsi/gm/cc, said glassy carbon layer provides a continuous matrix surface, and said disk substrate has a stability temperature of at least about 300° C.

28. The storage device as recited in claim 27, wherein said glassy carbon layer provides a burnishable surface.

29. A method of fabricating a disk substrate for a storage device, said method comprising the steps of:
providing a core;
applying a glassy carbon polymer precursor composition over at least one surface of said core;
heating said core having said glassy carbon polymer precursor composition applied thereto at a pyrolyzing temperature associated with said polymer precursor composition to form a glassy carbon layer, said glassy carbon layer adhering to said surface of said core.

30. The method of fabricating a disk substrate as recited in claim 29, wherein said applying step comprises the step of ultrasonically coating said glassy carbon polymer precursor composition over said surface of said core.

31. The method of fabricating a disk substrate as recited in claim 29, wherein said applying step comprises the step of airbrushing said glassy carbon polymer precursor composition over said surface of said core.

32. The method of fabricating a disk substrate as recited in claim 29, wherein said applying step comprises the step of spin coating said glassy carbon polymer precursor composition over said surface of said core.

33. The method of fabricating a disk substrate as recited in claim 29, wherein said glassy carbon polymer precursor composition comprises a three dimensional cross-linking polymer.

34. The method of fabricating a disk substrate as recited in claim 29, wherein said glassy carbon polymer precursor composition is selected from the group consisting of a phenolic, polyfurfuryl alcohol, cellulose, polybutylene, polyacrylonitrile, polyvinylidene chloride, polyvinyl chloride, polyvinyl fluoride, a polyimide, styrene-divinylbenzene co-polymer, polyphenylene oxide, polyphenylene sulfide, a polyarylacrylate, a phenylacetylene, and mixtures thereof.

35. The method of fabricating a disk substrate as recited in claim 29, wherein said applying step comprises the step of applying a glassy carbon polymer precursor composition over at least one surface of said core to a thickness not exceeding about 80 microns.

36. The method of fabricating a disk substrate as recited in claim 29, wherein said applying step comprises the step of applying a glassy carbon polymer precursor composition over at least one surface of said core to a thickness of about 0.1 microns to about 30 microns.

37. The method of fabricating a disk substrate as recited in claim 29, wherein said pyrolyzing temperature during said heating step is at least about 1000° C.

38. The method of fabricating a disk substrate as recited in claim 29, wherein said pyrolyzing temperature during said heating step is about 300° C. to about 1000° C. so that said glassy carbon layer comprises a pseudo glassy carbon pyropolymer.

39. The method of fabricating a disk substrate as recited in claim 29, further comprising the step of applying a bonding layer between said core and said glassy carbon layer.

40. The method of fabricating a disk substrate as recited in claim 39, wherein said bonding layer comprises a thin film of an inorganic or metal organic reactive adhesive agent selected from the group consisting of an organic complex of silicon, an organic complex of titanium, an organic complex of aluminum, an organic complex of zirconium, an inorganic complex of silicon, an inorganic complex of titanium, an inorganic complex of aluminum, an inorganic complex of zirconium, and mixtures thereof.

41. The method of fabricating a disk substrate as recited in claim 29, further comprising the step of etching said surface of said core with an acid prior to said applying step to provide acidic surface sites.

42. The method of fabricating a disk substrate as recited in claim 41, wherein said acid is selected from the group consisting of nitric, nitrous, sulfuric, sulfurous, sulfamic, phosphoric, pyrophosphoric, phosphorous, perchloric, hydrochloric, chlorous, hypochlorous, hydrofluoric, carbonic, chromic, and mixtures thereof.

43. The method of fabricating a disk substrate as recited in claim 29, further comprising the step of etching said surface of said core with a caustic material prior to said applying step to generate reactive hydroxyl groups on said surface of said core.

44. The method of fabricating a disk substrate as recited in claim 43, wherein said caustic material is selected from the group consisting of lithium hydroxide, sodium hydroxide, potassium hydroxide, calcium hydroxide, ammonium hydroxide, and mixtures thereof.

45. The method of fabricating a disk substrate as recited in claim 29, further comprising the step of oxidizing said surface of said core prior to said applying step.

46. The method of fabricating a disk substrate as recited in claim 29, further comprising the step of mechanically roughening said surface of said core prior to said applying step.

47. The method of fabricating a disk substrate as recited in claim 46, wherein said mechanically roughening step comprises the step of lapping or polishing said surface of said core.

48. A method of fabricating a data storage disk for a storage device, said method comprising the steps of:
providing a core;
applying a glassy carbon polymer precursor composition over at least one surface of said core;
heating said core having said glassy carbon polymer precursor composition applied thereto at a pyrolyzing temperature associated with said polymer precursor composition to form a glassy carbon layer, said glassy carbon layer adhering to said surface of said core;
burnishing said glassy carbon layer to form a burnished glassy carbon surface;
applying a recording layer over said burnished glassy carbon surface.

49. The method of fabricating a data storage disk as recited in claim 48, wherein said burnishing step includes the steps of:
applying a hydrocarbon lubricant on said glassy carbon layer;
micro-machining said glassy carbon layer by applying a burnishing head or a burnishing tape against said glassy carbon layer having said hydrocarbon lubricant applied thereto;
applying an aqueous or non-aqueous cleaning solution on said glassy carbon layer after said micro-machining step to remove said hydrocarbon lubricant.

50. The method of fabricating a data storage disk as recited in claim 49, wherein said hydrocarbon lubricant is a linear or branched alcohol or alcohol alkoxylate.
